(19) United States
(12) Patent Application Publication
(10) Pub. No.: US 2014/0158940 A1
(43) Pub. Date: Jun. 12, 2014

(54) Production of Synthesis Gas From Biosolid-Containing Sludges Having a High Moisture Content

(71) Applicants: Shahram Navaee-Ardeh, Sherbrooke (CA); Esteban Chornet, Sherbrooke (CA)

(72) Inventors: Shahram Navaee-Ardeh, Sherbrooke (CA); Esteban Chornet, Sherbrooke (CA)

(21) Appl. No.: 13/943,090

(22) Filed: Jul. 16, 2013

Related U.S. Application Data
(60) Provisional application No. 61/674,914, filed on Jul. 24, 2012.

(51) Int. Cl. C01B 3/36; C10J 3/72

(52) U.S. Cl. CPC C01B 3/36; C10J 3/725
USPC 252/373; 252/372

(57) ABSTRACT

A method of producing a synthetic gas or a synthesis gas from a biosolid, such as dewatered sludge, that has a solids content that does not exceed 30 wt. %. The biomass having a solids content that does not exceed 30 wt. % is mixed with tar-rich materials and/or char particles, and optionally a bulking agent. The tar-rich materials and/or char particles may be a by-product of producing synthesis gas from a biomass such as refuse-derived fuels. The resulting mixture then is heated to provide a mixture having a solids content of at least 75 wt. %. The mixture having a solids content of at least 75 wt. % then is gasified under conditions to produce a synthetic gas rich in CO/CO₂ or a synthesis gas rich in H₂/CO.

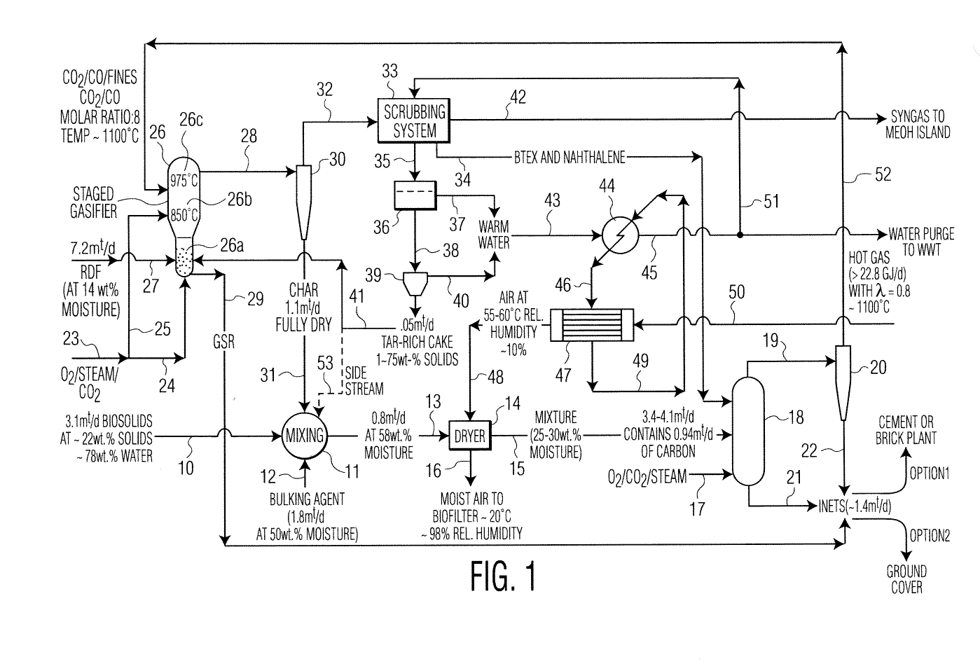

This application claims priority based on application Ser. No. 61/674,914, filed Jul. 24, 2012, the contents of which are incorporated by reference in their entirety.

This invention relates to producing synthesis gas from wet biosolid materials, such as sludge, having a low solids content, i.e., no greater than 30 wt. %. More particularly, this invention relates to producing a synthetic gas rich in CO and CO₂, or a synthesis gas rich in H₂ and CO from such wet biosolid materials by mixing them with tar-rich materials and/or carbon-containing char particles from the process itself or from other processes. Such mixture then has its moisture content lowered to less than 25 wt. % by drying such mixture. This mixture then is oxidized partially to produce a synthetic gas, which may be a synthetic gas having a low calorific value (typically <10 MJ/Nm³) or a synthesis gas (rich in H₂ and CO) that can be used for chemical synthesis.

Waste water treatment plants often include primary and secondary clarifiers, which produce a sludge containing biosolids that can be dewatered partially by mechanical dewatering units. In most cases, however, the dewatered sludge has a solids content that does not exceed 25 wt. %. Such biosolids may contain substantial populations of bacteria. Land disposal of such biosolids is costly, and limited by the availability of land disposal sites, as well as by regulations that need to be met before disposing the biosolids. Such biosolids often emit undesirable odors.

It therefore is an object of the present invention to provide a better method of disposing of such biosolids, by converting them to a synthetic gas. Thus, in accordance with an aspect of the present invention, there is provided a method of producing a synthetic gas from a biosolid having an initial solids content that does not exceed 30 wt. %. The method comprises admixing the biosolid having an initial solids content that does not exceed 30 wt. % with a solid material that comprises tar-rich materials and/or char particles to provide a mixture comprising the biosolid having an initial solids content that does not exceed 30 wt. % and the tar-rich materials and/or char particles. The mixture is dried whereby the mixture, when dried, has a solids content of at least 75 wt. %. The mixture then is gasified under conditions to produce a synthetic gas, rich in CO and CO₂, or a synthesis gas rich in H₂ and CO.

In a non-limiting embodiment, the biosolid material has an initial solids content that does not exceed 25 wt. %. In another non-limiting embodiment, the biosolid material has an initial solids content that does not exceed 20 wt. %.

Biosolid materials which have an initial solids content that does not exceed 30 wt. % include, but are not limited to, mixed sludge produced by waste water treatment plants, biorefinery waste water treatment plants, farm industry waste water treatment plants, pulp and paper industry waste water treatment plants, food industry waste water treatment plants, and petroleum industry waste water treatment plants.

In a non-limiting embodiment, the biosolid having an initial solids content that does not exceed 30 wt. % is contacted with a material that comprises tar-rich materials and/or char particles, and a bulking agent. Bulking agents which may be employed include, but are not limited to, shredded wood, and wood residues, agricultural residues, such as straw, sawdust, and shredded construction demolition materials.

When the biosolid having an initial solids content that does not exceed 30 wt. % is contacted with tar-rich materials and/or char particles, and a bulking agent, the resulting mixture, in a non-limiting embodiment, includes the bulking agent in an amount of up to about 35 wt. %, and the biosolid and tar-rich materials and/or char in a combined amount of from about 65 wt. % to about 90 wt. % of the resulting mixture. In another non-limiting embodiment, the bulking agent is present in an amount up to 30 wt. % of the resulting mixture, and the biosolids and tar-rich materials and/or char particles are present in a combined amount of about 70 wt. % of the resulting mixture.

The mixture of the biosolid material having an initial solids content that does not exceed 30 wt. %, the tar-rich materials and/or char particles, and optionally a bulking agent, is heated such that there is provided a mixture that has a solids content of at least 75 wt. %. In a non-limiting embodiment, the mixture, after heating, has a solids content of at least 80 wt. %. In a non-limiting embodiment, the mixture is heated to a temperature of from about 40° C. to about 85° C. In another non-limiting embodiment, the mixture is heated to a temperature of from about 55° C. to about 80° C.

In a non-limiting embodiment, the tar-rich materials and/or char particles, which are mixed with the biosolid material having a solids content that does not exceed 30 wt. %, are produced as a by-product of a process for producing a synthetic gas or synthesis gas by gasifying a biosolid-rich material, such as refuse-derived fuel, either from residential waste or from institutional, commercial, and industrial waste, wood and wood residues, agricultural residues (such as straw), construction and demolition wood, as well as residual materials from petrochemical refineries and biorefineries. The tar-rich materials and/or char particles have a solids content of at least 75 wt. %. Thus, in a non-limiting embodiment, a biosolid-rich material having a solids content of at least 75 wt. %, is gasified under conditions to produce a product comprising a crude synthetic gas or synthesis gas and tar-rich materials and/or char particles. The tar-rich materials and/or char particles then are separated from the crude synthetic gas or synthesis gas. The tar-rich materials and/or char particles, which essentially are dry, then are mixed with the biosolid material having an initial solids content that does not exceed 30 wt. %. In a non-limiting embodiment, the bulking agent may be mixed with the biosolid material having an initial solids content that does not exceed 30 wt. % and the tar-rich materials and/or char particles. The resulting mixture of the biosolid material that has an initial solids content that does not exceed 30 wt. %, and the tar-rich materials and/or char particles, and optionally a bulking agent such as hereinabove described, then is heated as hereinabove described whereby the mixture, after heating, has a solids content of at least 75 wt. %. The resulting mixture then is gasified to produce a synthesis gas.

The invention now will be described with respect to the drawing, wherein:

The drawing is a schematic of an embodiment of the method of the present invention.

Referring now to the drawing, a biosolid having a solids content that does not exceed 30 wt. %, in line 10, is passed to mixer 11, wherein the biosolid having a solids content that does not exceed 30 wt. % is mixed with a bulking agent, such as shredded wood from line 12, and tar-rich materials and/or char particles from line 31. Optionally, tar-rich materials also may be passed to mixer 11 from line 53. The resulting mixture, which includes the biosolid that has a solids content that initially does not exceed 30 wt. %, tar-rich materials and/or char particles, and a bulking agent is withdrawn from mixer 11 through line 13 and passed to dryer 14. In dryer 14, the mixture of biosolid having a solids content that does not exceed 30 wt. %, tar-rich materials and/or char particles, and bulking agent is contacted with a heated gas, such as heated air, from line 48. In general, the heated gas has a low relative humidity which should not exceed 20%. In a non-limiting embodiment, the mixture of biosolid having a solids content that initially does not exceed 30 wt. %, tar-rich materials and/or char particles, and bulking agent is contacted with the heated air at a temperature of from about 55° C. to about 80° C.

In dryer 14, the mixture of biosolid having a solids content that initially does not exceed 30 wt. %, tar-rich materials and/or char particles, and bulking agent is dried by air to provide a mixture of biosolid, tar-rich materials and/or char particles, and bulking agent that has a solids content of at least 75 wt. %. Moist air is withdrawn from dryer 14 through line 16, and the mixture of biosolid, tar-rich materials and/or char particles, and bulking agent, now having a solids content of at least 75 wt. %, is withdrawn from dryer 14 through line 15 and passed to partial oxidizer 18. In partial oxidizer 18, the mixture of biosolid, tar-rich materials and/or char particles, and bulking agent, is contacted with a mixture of oxygen, carbon dioxide, and steam from line 17. Added (if desired) high molecular weight (C₆ and above) hydrocarbons (such as, but not limited to, naphthalene) and oxygenates (such as phenolics) that could be formed in the gasifier 26 and separated downstream, could be introduced via line 34. In the partial oxidizer 18, a temperature is reached to convert the mixture of biosolid, tar-rich materials and/or char particles and bulking agent, and added hydrocarbons and oxygenates, to produce a gas rich in CO and CO₂. In general, the mixture of biosolid, tar-rich materials and/or char particles, bulking agent, and hydrocarbons/oxygenates, is heated in partial oxidizer 18 to a temperature of from about 850° C. to about 1,200° C. Inert solid materials, such as ash, for example, are withdrawn from partial oxidizer 18 through line 21, and the gas is withdrawn from partial oxidizer 18 through line 19 and passed to cyclone 20. In cyclone 20, additional inert solid particles are separated from the crude synthesis gas, and are withdrawn from cyclone 20 through line 22. The crude synthesis gas, which also may include materials such as carbon dioxide and fines, is withdrawn from cyclone 20 through line 52 and passed to stage 26c of gasifier 26.

While a biosolid having an initial solid content that does not exceed 30 wt. % is being converted to a crude synthesis gas as hereinabove described, a biosolid, such as a refuse derived fuel, which has a high solids content, typically at least 75 wt. %, is sent through line 27 to the fluidized bed section 26a of a gasifier 26. In the fluidized bed section 26a, the biosolid is contacted with a mixture of oxygen, carbon dioxide, and steam, which is passed through lines 23 and 24 to fluidized bed section 26a. Also fed to the fluidized bed section 26a is a tar-rich material from line 41. The biosolid, in fluidized bed section 26a, is heated to a temperature sufficient to provide a partially oxidized biosolid-derived intermediate product. In general, the biosolid is heated in fluidized bed section 26a to a temperature of about 700° C. to provide a partially oxidized biosolid-derived intermediate product. Inert materials are withdrawn from fluidized bed section 26a through line 29. The partially oxidized biosolid-derived intermediate product then is passed from fluidized bed section 26a of gasifier 26 to stage 26b of gasifier 26, where the partially oxidized biosolid-derived intermediate product is contacted with oxygen, carbon dioxide, and steam from line 25, to provide a crude synthesis gas. In general, in stage 26b, the oxidized biosolid-derived intermediate product is heated to a temperature of about 800° C. The crude synthesis gas then is passed from stage 26b of gasifier 26 to stage 26c, wherein the crude synthesis gas is contacted with the crude synthesis gas from line 52. The crude synthesis gas in stage 26c is heated to a temperature that results in further reforming of the crude synthesis gas. In general, in a non-limiting embodiment, the crude synthesis gas is heated in stage 26c of gasifier 26 to a temperature of about 975° C.

The synthesis gas, which also includes fines, tar-rich materials and/or char particles, and other impurities, is withdrawn from stage 26c through line 28, and is passed to cyclone 30.

In cyclone 30, the crude synthesis gas is separated from the tar-rich materials and/or char particles. The tar-rich materials and/or char particles are withdrawn from cyclone 30 through line 31, and are passed to mixer 11, where the tar-rich materials and/or char particles are mixed with the biosolid having a solids content that initially does not exceed 30 wt. % from line 10, and the bulking agent from line 12, and optionally with tar-rich materials from line 53.

The crude synthesis gas is withdrawn from cyclone 30 through line 32 and is passed to scrubber 33, in which the synthesis gas is contacted with water from line 51. A purified synthesis gas is withdrawn from scrubber 33 through line 42. Naphthalene, phenol, and other impurities such as BTEX (bezene, toluene, ethylbenzene, and xylene), are withdrawn from scrubber 33 through line 34, and sent to partial oxidizer 18, wherein the naphthalene and other impurities are heated with the mixture of biosolid, tar-rich materials and/or char particles, bulking agent to provide a gas rich in CO/CO₂.

Water and solid impurities such as tar and char are withdrawn from scrubber 33 through line 35 and passed to decanter 36. Water is withdrawn from decanter 36 through line 37, and a mixture of remaining water and solid impurities, such as tar and char, is withdrawn from decanter 36 through line 38, and passed to centrifuge 39. In centrifuge 39, a tar-rich material and/or char is (are) separated from the remaining water. The remaining water is withdrawn from centrifuge 39 through line 40. and is combined with the water from line 37 in line 43, where the water is at a temperature of from about 70° C. to about 90° C. The tar-rich material and/or char is (are) withdrawn from centrifuge 39 through line 41 and is (are) passed to the fluidized bed section 26a of gasifier 26, wherein the tar-rich material and/or char is (are) heated along with the refuse-derived fuel to provide a partially oxidized biomass. A side stream of the tar-rich material may be passed through line 53 to mixer 11, wherein such tar-rich material is mixed with the biosolid having a solids content that initially does not exceed 30 wt. %, tar-rich material and/or char particles, and the bulking agent.

The water in line 43 is passed to heat exchanger 44, wherein a stream of fluid from line 49 takes heat from the water. Cooled water, at a temperature of from about 30° C. to about 40° C., then is withdrawn from heat exchanger 44 through line 45. The heated air is withdrawn from heat exchanger 44 through line 46 and is passed to air-fluid heat exchanger 47. Also passed to air-fluid heat exchanger 47 is ambient air from line 50. In air-fluid heat exchanger 47, the heated air from line 46 and the ambient air from line 50 are dehumidified to provide heated air, at a temperature of from about 55° C. to about 80° C., and at a relative humidity of less than 20%. The heated and dehumidified air is withdrawn from air-fluid heat exchanger 47 through line 48 and is passed to dryer 14, where the heated and dehumidified air heats the mixture of the biosolid having an initial solids content that does not exceed 30 wt. %, the tar-rich material and/or char particles, and the bulking agent to provide a mixture of biosolid, tar-rich materials and/or char particles and bulking agent, that has a solids content of at least 75 wt. %. A stream of fluid is withdrawn from dehumidifier 47 through line 49.

The disclosure of all patents and publications (including published patent applications) are incorporated herein by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A method of producing a synthetic gas rich in CO and CO₂ or a synthesis gas rich in H₂ and CO from a biosolid having an initial solids content that does not exceed 30 wt. %, comprising:
(a) admixing said biosolid having an initial solids content that does not exceed 30 wt. % with a solid material that comprises tar-rich materials and/or char particles to provide a mixture comprising said biosolid having an initial solids content that does not exceed 30 wt. % and said tar-rich materials and/or char particles;
(b) drying said mixture whereby said mixture, after drying, has a solids content of at least 75 wt. %; and
(c) partially oxidizing said mixture under conditions to produce a synthetic gas rich in CO and CO₂ or a synthesis gas rich in H₂ and CO.

2. The method of claim 1 wherein said biosolid has an initial solids content that does not exceed 25 wt. %.

3. The method of claim 2 wherein said biosolid has an initial solids content that does not exceed 20 wt. %.

4. The method of claim 1 wherein said biosolid that has an initial solids content that does not exceed 30 wt. % is contacted with a material that comprises tar-rich materials and/or char particles, and a bulking agent.

5. The method of claim 4 wherein said bulking agent comprises shredded wood.

6. The method of claim 1 wherein said mixture, after heating, has a solids content of at least 80 wt. %.

7. The method of claim 1 wherein said mixture, in step (b), is dried by heating the mixture to a temperature of from about 40° C. to about 85° C.

8. The method of claim 7 wherein said mixture, in step (b), is heated to a temperature of from about 55° C. to about 80° C.
